(19) United States
(12) Patent Application Publication
(10) Pub. No.: US 2014/0096425 A1
(43) Pub. Date: Apr. 10, 2014

(54) GOLF CLUB LABELING APPARATUS AND METHOD OF USE THEREOF

(71) Applicant: Robert J. Frazier, Goodyear, AZ (US)

(72) Inventor: Robert J. Frazier, Goodyear, AZ (US)

(21) Appl. No.: 14/045,981

(22) Filed: Oct. 4, 2013

Related U.S. Application Data
(60) Provisional application No. 61/709,841, filed on Oct. 4, 2012.

(51) Int. Cl. G09F 3/06

(52) U.S. Cl. CPC G09F 3/06
USPC 40/673; 29/428

(57) ABSTRACT

A golf club labeling apparatus is provided. The apparatus includes a body having a first end and a second end, the first and second ends being opposed to one another; a bore in the body, the bore extending from the first end to the second end, and the bore defining a sidewall in the body; an opening in the body, the opening being configured in the sidewall, the opening extending from the first end to the second end; and an indicator on the body, wherein the indicator is a number corresponding to a distance, wherein the opening is configured to allow the marker to be releasably coupled to the object such that the bore functionally engages the object and the indicator is visible.

### CROSS REFERENCE TO RELATED APPLICATION[S]

This application claims priority to U.S. Provisional Patent Application to Frazier entitled “GOLF CLUB LABELING APPARATUS AND METHOD OF USE THEREOF,” Ser. No. 61/709,841, filed Oct. 4, 2012, the disclosure of which is hereby incorporated entirely herein by reference.

### BACKGROUND

1. Technical Field

This disclosure relates generally to a labeling apparatus, and in particular to a golf club labeling apparatus and a method of using the same.

2. State of the Art

A golf club set commonly includes clubs of various types, including drivers, irons, and wedges, among others. These various types of clubs allow a golfer to hit the golf ball a certain desired distance, depending on course conditions and distance to a target while making the same general swing. This is generally because the loft of the various types of golf clubs can be different from club to club, ranging progressively from 10 degrees or less to 65 degrees or more. For example, a driver or a one-iron may have a 10 degree loft, whereas a wedge may have a 65 degree loft. Further in example, a long iron may have a lower degree of loft in comparison to a short iron that may have a greater degree of loft. Because the loft is different from club to club, the idea is that the golfer's same swing will produce a different loft on the golf ball, and thus a different distance the ball will travel in the air.

Most golf clubs are labeled with a number indicating their loft; the higher the number, the higher the loft. A matched set of drivers or irons will usually have a regular, progressive increase in loft through the set. For example, drivers may range from 1 to 7, whereas irons may range from 0 through 10, but the most common number range in the modern iron set is 3 to 9, with 3 indicating a lesser degree of loft, or greater distance of ball flight using the same swing, and 9 indicating a greater degree of loft, or shorter distance of ball flight using the same swing.

However, despite the number on the club, the distance the golf ball will travel will depend almost entirely on the skill level and ability of the individual golfer, as well as the type of shot the golfer wishes to make with the selected club, i.e. fade shot, draw shot, low shot, and high shot. Also, each golfer has a unique swing and each golfer generates a particular club head speed due to that swing, each of which affects the distance the golf ball will travel in flight. Moreover, each golf club manufacturer designs its golf club set to specific proprietary standards, which influence the distance a four iron, for example, of different manufacturers, respectively, may cause a golf ball to travel in flight, even if all other swing factors were the same. Thus, not only does the ability of the golfer influence how far a golf ball will travel in flight depending on the specific club used by the golfer, but so too will the manufacturing standards of the golf club brand of the specific club used by the golfer.

Oftentimes, golf club manufacturers provide an estimate of how far a golfer should hit a golf ball using a particular club. However, due to the factors identified above, the estimated distance applies to the minority of individual golfers across the board. Indeed, golfers often rely on these standard distances to estimate the distance they will hit the golf ball with the club, which more often than not results in a less than favorable outcome. There is therefore a need in the golf industry for a labeling system and method of using the same that simplifies the game for the golfer by addressing the problems described herein.

### SUMMARY

The present disclosure relates generally to a labeling apparatus, and in particular to a golf club labeling apparatus and a method of using the same.

An aspect of the present disclosure includes a labeling apparatus for labeling an object, the apparatus comprising a body having a first end and a second end, the first and second ends being opposed to one another, a bore in the body, the bore extending from the first end to the second end, the bore defining a sidewall in the body, an opening in the body, the opening being configured in the sidewall, the opening extending from the first end to the second end, and an indicator on the body, wherein the indicator is a number corresponding to a distance, wherein the opening is configured to allow the apparatus to be releasably coupled to the object such that the bore functionally engages the object with the indicator being visible.

Another aspect of the present disclosure includes wherein the body is configured to flex to permit the opening to expand and contract as the apparatus encounters the object.

Another aspect of the present disclosure includes wherein the indicator is configured on the sidewall opposite the opening.

Another aspect of the present disclosure includes wherein the distance is a user-defined distance corresponding to a measured length another object travels by the user propelling the another object by swinging the object to make contact with the another object.

Another aspect of the present disclosure includes wherein the bore has an elliptical cross section having a minor axis, the opening being centered on the minor axis on a sidewall of the body.

Another aspect of the present disclosure includes wherein opposing side edges of the opening are parallel with respect to one another.

Another aspect of the present disclosure includes a system for labeling a golf club, the system comprising, a marker comprising a body having a first end and a second end, the first and second ends being opposed to one another, a bore in the body, the bore extending from the first end to the second end, and the bore defining a body sidewall, an opening in the sidewall, the opening extending from the first end to the second end, and an indicator on the body, wherein the indicator is a measurement of distance, and a golf club having a shaft, wherein the opening is configured to allow the marker to be releasably coupled to the shaft such that the bore functionally engages the shaft with the indicator being visible, and wherein the measurement corresponds to how far a golf ball travels under the condition the user swings the golf club to make contact and propel the golf ball.

Another aspect of the present disclosure includes wherein the body is configured to flex such that the opening expands as the shaft passes through the opening and the opening retracts after the shaft has passed through the opening.

Another aspect of the present disclosure includes wherein the bore has an elliptical cross section having a minor axis, the opening being centered on the minor axis on the sidewall of the body.

Another aspect of the present disclosure includes wherein opposing side edges of the opening are parallel with respect to one another and parallel with the minor axis.

Another aspect of the present disclosure includes wherein opposing side edges of the opening are angled with respect to one another.

Another aspect of the present disclosure includes a plurality of markers, each of the plurality of markers being configured to have a different indicator thereon, and a plurality of golf clubs, wherein each marker is releasably coupled to a corresponding one of the plurality of golf clubs based on the measurement of distance associated with how far the golf ball travels under the condition the golf ball is hit by the corresponding one of the plurality of golf clubs.

Another aspect of the present disclosure includes a plurality of markers, each of the plurality of markers being configured to have an indicator thereon, and a plurality of golf clubs, wherein two or more markers are releasably coupled to a corresponding one of the plurality of golf clubs based on the measurement of distance associated with how far the golf ball travels according to a swing type used by the golfer with the corresponding one of the plurality of golf clubs, each of the swing types resulting in a different measure of distance.

Another aspect of the present disclosure includes wherein the swing type is one of a straight shot, a draw shot, a fade shot, and less-than-full-powered shot.

Another aspect of the present disclosure includes a plurality of markers, each of the plurality of markers being configured to have an indicator thereon, and a plurality of golf clubs, wherein two or more markers are releasably coupled to a corresponding one of the plurality of golf clubs based on the measurement of distance associated with how far the golf ball travels according to conditions of a golf course, each of the conditions resulting in a different measure of distance.

Another aspect of the present disclosure includes wherein the conditions are one of an uphill lie, a downhill lie, a sidehill lie, weather, and grass type.

Another aspect of the present disclosure includes a method of labeling a golf club set, the method comprising providing a set of golf clubs, providing a set of markers having indicators thereon, the indicators displaying a number, selecting a golf club of the set of golf clubs, hitting a golf ball with the golf club, measuring a distance the golf ball travels, identifying which marker among the set of markers displays the number that corresponds to the measured distance, and coupling the identified marker to the golf club.

Another aspect of the present disclosure includes inserting a shaft of the golf club into an opening on the identified marker, expanding the opening to receive the shaft, retracting the opening after receiving the shaft, and securing the identified marker to the shaft by friction fit.

Another aspect of the present disclosure includes selecting a second golf club of the set of golf clubs, hitting a golf ball with the second golf club, measuring a second distance the golf ball travels, identifying which marker among the set of markers displays the number that corresponds to the second measured distance, and coupling the identified marker to the second golf club.

Another aspect of the present disclosure includes utilizing a different swing type to hit the golf ball with the golf club, measuring a distance the golf ball travels by the different swing type, identifying which marker among the set of markers displays the number that corresponds to the measured distance by the different swing type, coupling the identified marker for the different swing type to the golf club, and distinguishing the identified marker for the different swing type from the identified marker.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a front perspective view of an embodiment of a marker of a labeling system in accordance with the present disclosure.

FIG. 2 is a top view of an embodiment of a marker of a labeling system in accordance with the present disclosure.

FIG. 3 is a front side view of an embodiment of a marker of a labeling system in accordance with the present disclosure.

FIG. 4 is a top perspective view of an embodiment of a marker of a labeling system in accordance with the present disclosure.

FIG. 5 is a perspective view of an embodiment of a marker of a labeling system placed upon an object to label the object in accordance with the present disclosure.

FIG. 6 is a back perspective view of an embodiment of a marker of a labeling system having an indicator thereon in accordance with the present disclosure.

FIG. 7 is a front perspective view of an embodiment of a plurality of markers of a labeling system placed upon respective objects to label the objects in accordance with the present disclosure.

FIG. 8 is perspective view of an embodiment of an object to be labeled in accordance with the present disclosure.

FIG. 9 is a top view of an embodiment of a marker of a labeling system in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

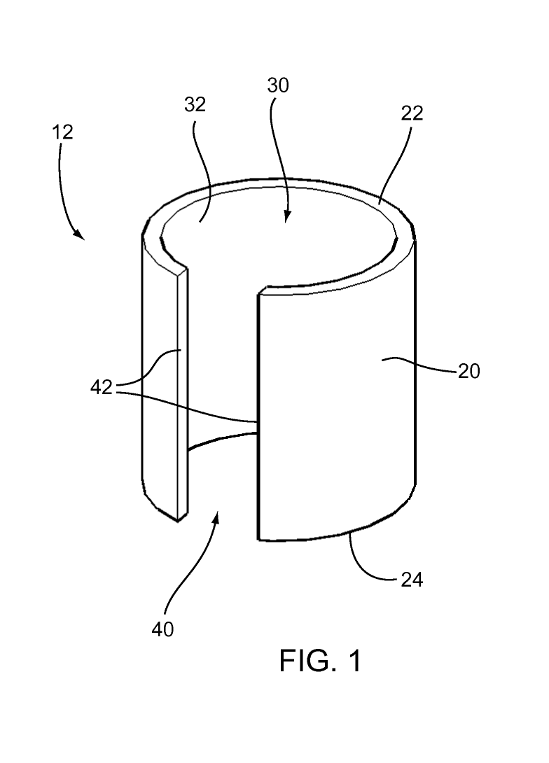

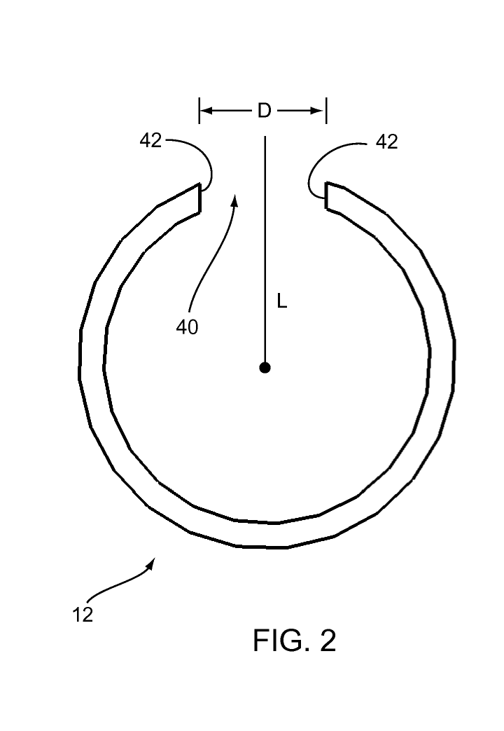

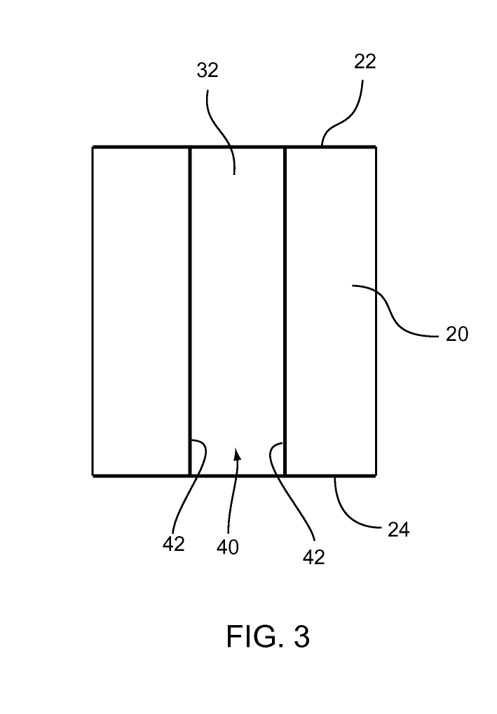

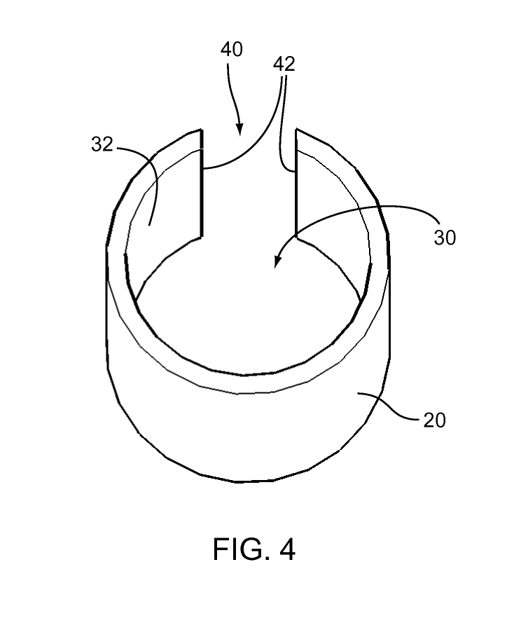

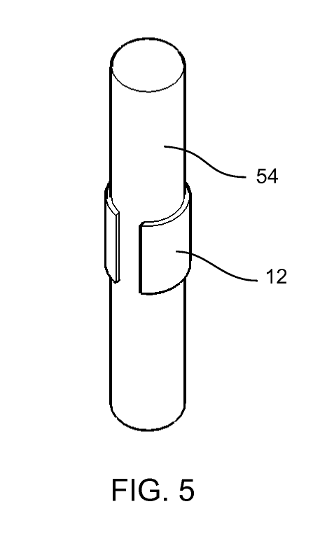

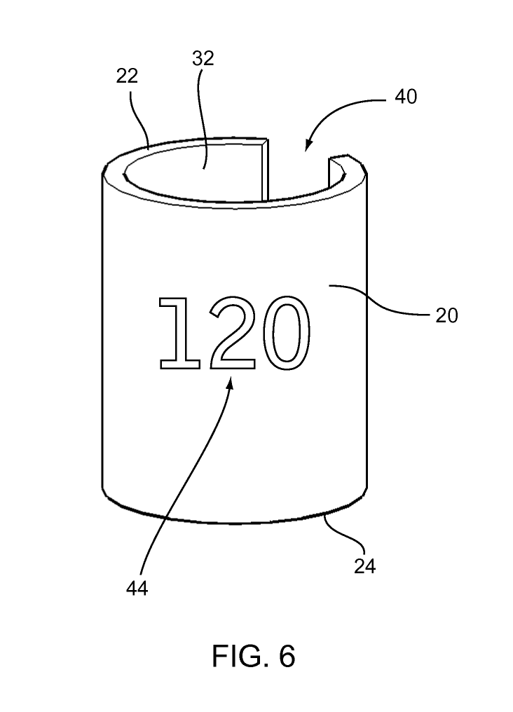

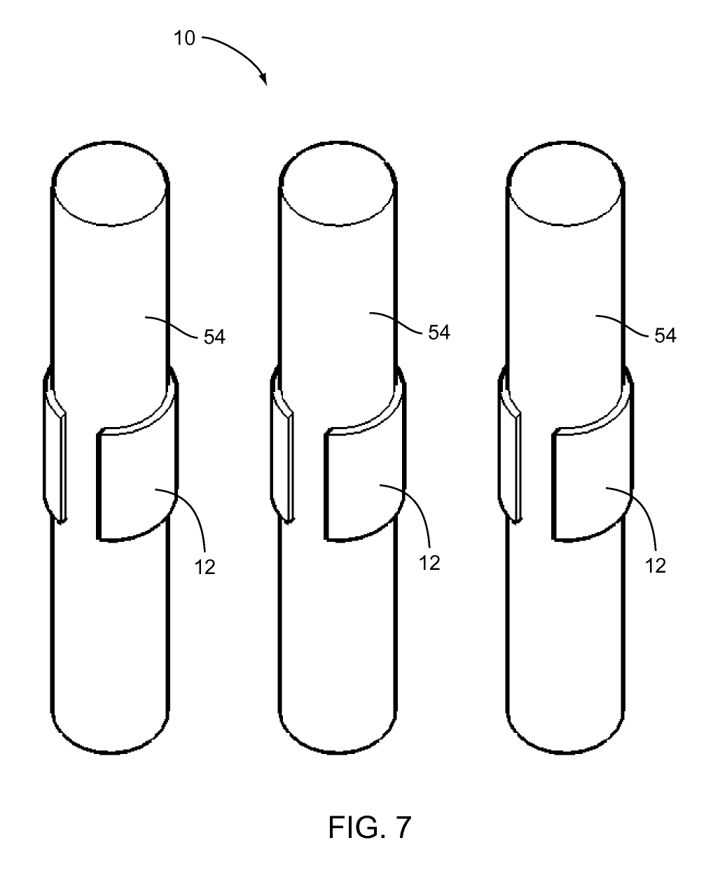

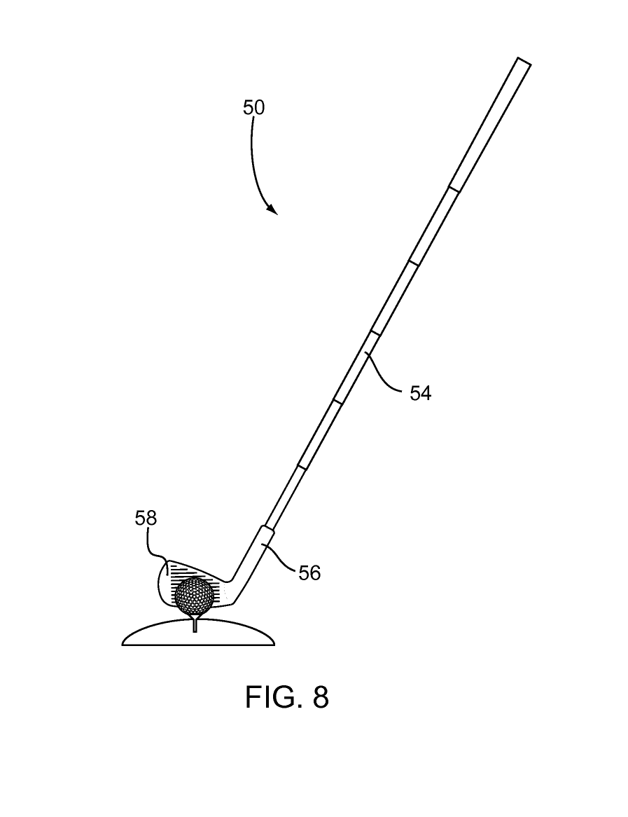

Referring to the drawings, FIGS. 1-8 depict an embodiment of a labeling system 10. Embodiments of the labeling system 10 may comprise various structural components that complement one another to provide the unique functionality and performance of the system 10, the structure and function of which will be described in greater detail herein. Embodiments of the system 10 may comprise a label, or a marker 12, a plurality of markers 12, and/or, among other features, a marker 12 and a golf club 50.

The marker 12 may comprise a body 20, a central bore 30 in the body 20, an opening 40 in the body 20, and the body 20 being configured to releasably and repeatedly couple to another object. Embodiments of the system 10 may include the body 20 being cylindrical in shape and may include a first end 22 and a second end 24 that substantially oppose one another. Embodiments of the system 10 may include the central bore 30 being a through bore that runs through the entire length of the body 20 from the first end 22 to the second end 24. The bore 30 may be axially aligned with the cylindrical axis of the body 20. Embodiments of the system 10 may include the opening 40 being a gap, slit, hole, split, or other slot, in the sidewall of the body 20 that runs the entire length of the system 10 from the first end 22 to the second end 24. The length of the opening 40 may be parallel with the axis of the body 20.

Embodiments of the system 10 may comprise the bore 30 having a diameter that is slightly smaller than the outer diameter of the body 20, such that the body 20 has a thickness and the thickness of the sidewall of the body 20 is thin enough to be flexible to elastically flex, or otherwise elastically bend, yet rigid enough to resist plastic deformation under normal operating stresses. The bore 30 may further comprise an interior surface 32 that is configured to functionally engage a surface of another object.

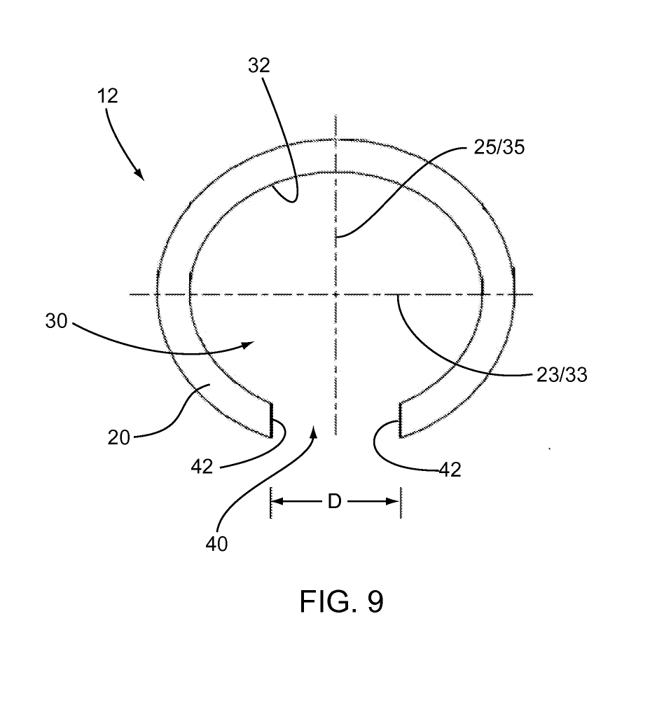

Embodiments of the system 10 may comprise the body 20 having a slightly oblong, oval-shaped or elliptical configuration, as exemplarily depicted in FIG. 9. For example, the body 20 may have a major axis 23 and a minor axis 25, wherein the major axis 23 has a length that is larger than a length of the minor axis 25. In like manner, the bore 30 may also be oblong, oval-shaped or have an elliptical configuration to match that of the body 20. For example, the bore 30 may have a major axis 33 and a minor axis 35, wherein the major axis 33 has a length that is larger than a length of the minor axis 35, and the major axis 33 of the bore 30 being oriented with the major axis 23 of the body 20. In this way, the bore 30 may have an elliptical shape to permit the interior surface 32 to better engage the surface of another object placed within the bore 30. The length of the outer diameter of the major axis 23 of the body 20 may be, for example, about 11 mm, whereas the length of the outer diameter of the minor axis 25 of the body 20 may be, for example, about 9.5 mm. The length of the diameter of the major axis 33 of the bore 30 may be, for example, about 9 mm, whereas the length of the diameter of the minor axis 35 of the bore 30 may be, for example, about 7.5 mm. As a result, the thickness of the sidewall of the body 20, defined between the outer surface of the body 20 and the interior surface 32 may be about 1.5 mm. Further, the opening 40 may be configured to have a distance D of about 4 mm, for example, between opposing edges 42. The length of the body 20 from the first end 22 to the second end 24 may be about 14 mm, for example.

Embodiments of the system 10 may comprise the opening 40 being defined by opposing edges 42 in the sidewall of the body 20. The opposing edges 42 may be separated a distance D apart from one another. The opposing edges 42 may be aligned parallel with one another along their respective lengths. The distance D may be configured to increase as the opposing edges 42 are temporarily moved away from one another to place the body 20 on another object, after which the opposing edges 42 may be configured to return to the distance D apart from one another. Indeed, the body 20 may be biased toward the opposing edges 42 being separated the distance D away from one another, such that under the condition that the opposing edges 42 are moved away from one another to increase the distance D, the body 20 opposes this movement. Thereafter, once the forces acting on the body 20 or the opposing edges 42 to move the opposing edges 42 away from one another cease, the biasing of the body 20 results in the opposing edges 42 moving back toward one another to reach the distance D, if possible.

Embodiments of the system 10 may include the body 20 being configured to have opposing edges 42 whose outer faces are aligned in parallel with a radial line L running from the center of the bore 30 to approximately the middle of the distance D. The line L is representative of a direction of motion that is useful to place the marker 12 on another object. In this way, the opposing edges 42 are aligned substantially in parallel with a direction of motion that facilitates the placing of the marker 12 around another object, thus allowing easier insertion of the marker 12 on the object.

Embodiments of the system 10 may include the body 20 being configured to be placed around a shaft 54 of a golf club 50. The golf club 50 may include a club head 58 and a hosel 56 on the club head 58 that is configured to receive the tip end 55 of the shaft 54, such that the shaft 54 and the club head 58 are coupled to one another under the condition that the tip end 55 of the shaft 54 is placed inside the hosel 56. The body 20 may be configured to be coupled to the shaft 54 just above the hosel 56, such that the body 20 is capable of being releasably and repeatedly coupled to the shaft 54. The body 20 may be coupled to the shaft 54 by orienting the opening 40 toward the shaft 54 and moving the body 20 toward the shaft 54, more or less in a direction parallel with the line L, until the shaft 54 slips through the opening 40 and the bore 30 engages the outer diameter of the shaft 54.

Embodiments of the system 10 further comprise the bore 30 having a diameter of between 0.320 inches to 0.360 inches inclusive. Embodiments of the system 10 may further comprise the bore 30 having a diameter of between 0.320 inches to 0.335 inches inclusive. The particular diameter of the bore 30 may be determined at the time of manufacture. A standard shaft 54 of a club 50 may range in diameter from between 0.335 inches to 0.370 inches, depending upon the club type and the club manufacturer. Embodiments of the system 10 may comprise the bore 30 having a diameter slightly smaller than the diameter of the shaft 54, thus allowing the body 20 to fit snugly around the shaft 54 and not thereafter move without undue force. In this way, once the marker 12 is placed around the shaft 54, the body 20 may not slide up and down the shaft 54 as the golfer swings, but may instead remain near the hosel 56, or near where the golfer places the marker 12 on the shaft 54.

Embodiments of the system 10 further comprise the opening 40 having a distance D between opposing edges 42. The distance D may range between 0.10 inches to 0.30 inches. The distance D should be less than the diameter of the bore 30 to ensure the body 20 may remain coupled to the shaft 54. The distance D provides a sufficient opening in which the shaft 54 of the club 50 may be inserted, such that the shaft 54 of the club 50 enters the bore 30 and is functionally engaged by the interior surface 32 of the bore 30.

As discussed herein, embodiments of the system 10 comprise the body 20 being flexible enough to elastically deform and yet rigid enough to resist plastic deformation. The body 20 may elastically deform by the opposing edges 42 of the opening 40 being configured to move away from one another to allow the shaft 54 to be inserted therein. As a result of the distance D increasing, the diameter of the bore 30 likewise temporarily increases. Once the shaft 54 is inserted through the opening 40 and into the bore 30, the opposing edges 42 move back toward one another to return to the distance D, or as close thereto as possible, and to decrease the diameter of the bore 30 until the interior surface 32 engages the shaft 54. Upon the condition that the shaft 54 is placed within the bore 30, the interior surface 32 of the bore 30 functionally engages the shaft 54 such that the body 20 does not thereafter move with respect to the shaft 54.

Embodiments of the system 10 may further comprise the body 20 having an indicator 44 thereon. The indicator 44 may be, for example, but not limited thereto, an indicator of distance. The indicator 44 may be any number within a certain range. The range may be between, for example, 40 and 320, in increments of 5, 10, or 20, the specific number corresponding to yardage on a golf course. Embodiments of the system 10 may further comprise the indicator 44 being a sticker that is functionally adhered to the body 20 of the marker 12. Embodiments of the system 10 may further comprise the indicator 44 being engraved, embossed, or otherwise etched, in the surface in the exterior of the body 20. Embodiments of the system 10 may further comprise the indicator 44 being hand-drawn on the body 20 by the manufacturer prior to use by the user or by the user during use of the system 10. The indicator 44 may be removable or replaceable, as needed, on the body 20 according to the golfer's individual need. The indicator 44 may be inserted into an insert section on the body 20, such that different indicators 44 may be inserted within the body 20 to differentiate each body 20 from one another in a customizable, user-determined manner. The indicator 44 may be positioned on an exterior of the body 20. The indicator 44 may be positioned on an exterior of the body 20 opposite the opening 40.

Embodiments of the system 10 may further comprise one or more indicators 44 being positioned on each marker 12. The one or more indicators 44 may be color-coded for distinguishing between indicators 44. The one or more indicators 44 may be sized differently for distinguishing between the one or more indicators 44 on each marker 12. The one or more indicators 44 may be releasably and repeatedly coupled to each marker 12, such that the one or more indicators 44 may be interchanged on each marker 12, for versatility, as needed by the golfer or user.

Embodiments of the system 10 may further comprise a plurality of markers 12 that comprise a set 14. The set 14 may comprise two or more markers 12, each marker 12 having a unique indicator 44 thereon. The set 14 may include each marker 12 having a progressive yardage distance indicator 44 thereon, the yardage being measured from, for example, 40 to 320 yards in increments of 5, in increments of 10, or in increments of 20. An individual marker 12, having its unique yardage indicator 44 thereon, may be placed on a shaft 54 of a corresponding golf club 50. More specifically, the golfer may choose the marker 12, with the indictor 44 thereon, to be placed on the shaft 54 of the club 50 that corresponds to the distance the golfer can drive the golf ball with that particular club 50. In this way, the golfer may use the set 14 to add a custom label to each of the clubs 50 in the golf club set, each club having its own marker 12, the marker 12 having a corresponding yardage indicator 44 thereon that corresponds to the distance the individual golfer using the set 14 can hit the particular club 50.

Alternatively, the indicator 44 may be placed on the marker 12 by the user. In other words, after determining how far the user may hit a golf ball with a particular golf club 50, the user may hand-draw an indicator 44, which may represent a yardage indicator, on the body 20 of the marker 12. In this way, only approximately 15-20 markers 12 may need to be included in the set 14, because the user may be able to customize the markers 12 according to individual performance and skill.

Embodiments of the system 10 may further comprise the marker 12 being a sticker having a front face with the indicator 44 thereon, as described herein, and a back face with an adhesive thereon for adhering to another object, such as a golf club 50 or the shaft 54 of a golf club 50.

Embodiments of the system 10 may further comprise the marker 12 being a magnet having a front face with the indicator 44 thereon, as described herein, and a back face with a magnetic backing for magnetically coupling to another object, such as a golf club 50 or the shaft 54 of a golf club 50.

Embodiments of the system 10 may include one or more markers 12 being placed on an object, such as a golf club 50 or the shaft 54 of a golf club 50. Each marker 12 may have an indicator 44 thereon that is different from the other markers 12. Moreover, each marker 12 may be coded, or otherwise identified, such as by color or size, to correspond to a particular type of golf shot that the golfer wishes to execute with the selected club 50 upon which the marker 12 has been placed. Each club 50 may be used to execute a variety of golf shots, such as, for example but not limited thereto, a straight shot, a fade, a draw, a low shot, a high shot, a less than 100% powered (less-than-full-powered) shot. Such execution of the various shot types requires a corresponding type of swing, which will vary the distance the golf ball travels, even though the club 50 remains the same. Thus, a plurality of markers 12 may be placed on any one particular golf club 50 or the shaft 54 of the golf club 50 to correspond to and indicate the distance each type of golf shot for that particular club 50 will cause the golf ball to travel. For example, a full-powered regular shot with a club 50 may cause the golf ball to travel 150 yards, whereas a fade shot with the same club 50 may cause the golf ball to only travel 120 yards. Thus, the golfer may utilize one marker 12 to indicate a normal swing of the club 50 will result in the golf ball traveling about 150 yards, whereas the golfer may utilize another marker 12 to indicate a fade swing of the club 50 will result in the golf ball traveling about 120 yards. These markers 12 that correspond to different types of swings may be color-coded or otherwise identified, such as, for example but not limited thereto, by size or texture or font or other symbol, to indicate to the golfer how far the golfer hits with the club 50 depending on the type of swing the golfer makes with the club 50. The identification feature, such as color, for a regular shot may be the same from club 50 to club 50. Likewise, the feature, such as color, for a draw shot may be the same from club 50 to club 50. Likewise, the feature, such as color, for a fade shot may be the same from club 50 to club 50. In this way, by looking at the marker 12 the golfer can immediately know which color on any one club 50 corresponds to the type of shot to be executed with the club 50, and, due to the indicator 44 on the marker 12, how far the golf ball should travel as a result.

Other markers 12 may be placed on the golf club 50 to indicate how far the golf ball will travel based on the type of swing the golfer wishes to execute. The golfer may utilize as many markers 12 as desired on a particular club 50 to indicate the distance the golf ball will travel for each shot the golfer is capable of making with the selected club 50. Embodiments of the system 10 may further comprise the markers 12 being configured with to be oriented with respect to one another on the golf club shaft 54 to align the indicators 44 on separate markers 12 with respect to one another along the length of the golf club shaft 54. For example, the markers 12 may be configured with a notch and groove on opposing ends of the marker 12, to mate or correspond with another marker 12 placed thereby. Thus, if a plurality of markers 12 are placed upon a shaft 54, the notch and groove on opposing ends of the marker 12 may align the indicators 44 on each of the markers 12. This makes it convenient for the golfer to view the indicators 44 on each marker in a single glance.

Other markers 12 may be placed on the golf club 50 to indicate how far the golf ball will travel based on the conditions encountered on the golf course by the golfer during a golf round. For example, the golfer may encounter an uphill lie, where the golf ball is resting on an uphill slant, a downhill lie, where the golf ball is resting on a downhill slant, and a sidehill lie, where the golf ball is resting above or below the feet of the golfer depending on the side slope of the golf course. In these various lies, the distance the golf ball travels may be affected. Further in example, the golfer may encounter colder weather (less than 50° F.) where the distance the golf ball travels may be affected by the cold temperatures. Further in example, the golfer may encounter warmer weather (above 50° F.) where the distance the golf ball travels may be affected by the cold temperatures. Further in example, the golfer may encounter various grass types that affect the distance the golf ball travels upon impact from the golf club 50.

A method of using the system 10 may herein be described with reference to the foregoing description and the following method steps. A set of golf club 50 may be provided. A set of markers 12 may be provided, each marker 12 having an indicator 44 thereon, the indicator 44 representative of a number corresponding to a distance related to a golf course, the number ranging from between 40 and 320. A golfer may select a particular golf club 50 from the set of golf clubs and hit a golf ball with that particular golf club 50. Thereafter, the golfer may determine by a yardage marker, a distance finder, or other distance measuring means or method, how far the golf ball has traveled. Based on the measured distance, the golfer may find the marker 12 in the set of markers 14 that corresponds to that particular measured distance, or corresponds as close as possible to that particular measured distance, and place that marker 12 on the particular golf club 50. Alternatively, the golfer may choose to hit the golf ball with that particular club 50 several times, measure the distance traveled for each swing, and calculate an average distance the ball traveled based on the several measured distances. Thereafter, the golfer may find the marker 12 in the set of markers 14 that corresponds to that particular average measured distance, or corresponds as close as possible to that particular average measured distance, and place that marker 12 on the particular golf club 50. As stated, once the golfer chooses the marker 12 that corresponds to the distance the golfer can hit the golf ball with that particular club 50, based on measured distance, the golfer may apply the marker 12 on the shaft 54 of the club 50.

Embodiments of the method further comprise the golfer executing a variety of swing types with a particular club 50. As a result, the distance the golf ball travels will vary depending on the shot/swing type the golfer executes, i.e., fade, draw, etc. The golfer may execute several different shot/swing types with the same club 50. Thereafter, the golfer may determine by a yardage marker, a distance finder, or other distance measuring means or method, how far the golf ball has traveled for each type of golf shot. Based on the measured distance, the golfer may find the marker 12 in the set of markers 14 that corresponds to that particular measured distance, or corresponds as close as possible to that particular measured distance. As a result, the golfer may choose several markers 12 for each club 50, each marker 12 corresponding to a distance the golf ball travels depending on the shot/swing type executed by the golfer using the particular club 50.

Embodiments of the method further comprise the golfer placing the indicator 44 on the marker 12 prior to placing the marker 12 on the club 50. In other words, the user may choose a marker 12 having no predetermined indicator 44 thereon, and thereafter hand-draw a desired indicator 44 thereon, the indicator 44 corresponding to the distance a user can hit a golf ball with a particular club 50. Thus, the user may customize each marker 12 with a user-defined yardage indicator.

Embodiments of the method further comprise the golfer placing the marker 12 on the golf club 50. Embodiments of the method further comprise the golfer placing the marker 12 on the shaft 54 of the club 50 by orienting the opening 40 toward the shaft 54 and pushing the marker 12 toward the shaft 54, such that the opening 40 engages the shaft 54. As a result, the opposing edges 42 of the body 20 engage the shaft 54 and move apart from one another to allow the shaft 54 to pass through the opening 40 and into the bore 30. Once the shaft 54 is positioned inside the bore 30, the opposing edges 42 move back toward one another until the inside surface 32 of the bore 30 functionally engages the shaft 54 to prevent the marker 12 from thereafter moving along the shaft 54 without undue force.

Embodiments of the method further comprise the golfer repeating the above-described steps until the desired number of clubs 50 in the golfer's set of clubs are labeled in this customized manner. Embodiments of the method further comprise the golfer repeating the described steps until the desired number of markers 12 are positioned on a particular golf club 50 to indicate the different yardage a golfer may hit the ball with the particular golf club 50 depending upon the shot/swing executed by the golfer.

Embodiments of the method further comprise the golfer playing a round of golf having the markers 12 on the clubs 50, such that once the golfer determines how far the golfer desires to hit the golf ball on a particular golf shot, the golfer need only find the golf club 50 having the marker 12 thereon that displays the indicator 44 that corresponds to the same or approximately the same distance.

Such a system and method removes the guesswork from selecting a club to hit on a particular golf shot. Moreover, such a system and method customizes a golfer's golf clubs 50 by labeling each club 50 with a customized distance indicator. No longer does a golfer have to rely exclusively on the number assigned to the loft of the golf club by the golf club manufacturer or the distance assigned to the golf club based on that number by the golf club manufacturer.

The components defining the above-described system 10 may be formed of any of many different types of materials or combinations thereof that can readily be formed into shaped objects provided that the components selected are consistent with the intended operation of a device of the type disclosed herein. For example, and not limited thereto, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described system 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A labeling apparatus for labeling an object, the apparatus comprising:
a body having a first end and a second end, the first and second ends being opposed to one another;
a bore in the body, the bore extending from the first end to the second end, the bore defining a sidewall in the body;
an opening in the body, the opening being configured in the sidewall, the opening extending from the first end to the second end; and
an indicator on the body, wherein the indicator is a number corresponding to a distance,
wherein the opening is configured to allow the apparatus to be releasably coupled to the object such that the bore functionally engages the object with the indicator being visible.

2. The apparatus of claim 1, wherein the body is configured to flex to permit the opening to expand and contract as the apparatus encounters the object.

3. The apparatus of claim 1, wherein the indicator is configured on the sidewall opposite the opening.

4. The apparatus of claim 1, wherein the distance is a user-defined distance corresponding to a measured length another object travels by the user propelling the another object by swinging the object to make contact with the another object.

5. The apparatus of claim 1, wherein the bore has an elliptical cross section having a minor axis, the opening being centered on the minor axis on a sidewall of the body.

6. The apparatus of claim 1, wherein opposing side edges of the opening are parallel with respect to one another.

7. A system for labeling a golf club, the system comprising:
a marker comprising:
a body having a first end and a second end, the first and second ends being opposed to one another;
a bore in the body, the bore extending from the first end to the second end, and the bore defining a body sidewall;
an opening in the sidewall, the opening extending from the first end to the second end; and
an indicator on the body, wherein the indicator is a measurement of distance; and
a golf club having a shaft,
wherein the opening is configured to allow the marker to be releasably coupled to the shaft such that the bore functionally engages the shaft with the indicator being visible, and
wherein the measurement corresponds to how far a golf ball travels under the condition the user swings the golf club to make contact and propel the golf ball.

8. The system of claim 7, wherein the body is configured to flex such that the opening expands as the shaft passes through the opening and the opening retracts after the shaft has passed through the opening.

9. The system of claim 7, wherein the bore has an elliptical cross section having a minor axis, the opening being centered on the minor axis on the sidewall of the body.

10. The system of claim 9, wherein opposing side edges of the opening are parallel with respect to one another and parallel with the minor axis.

11. The system of claim 7, wherein opposing side edges of the opening are angled with respect to one another.

12. The system of claim 7, further comprising:
a plurality of markers, each of the plurality of markers being configured to have a different indicator thereon; and
a plurality of golf clubs,
wherein each marker is releasably coupled to a corresponding one of the plurality of golf clubs based on the measurement of distance associated with how far the golf ball travels under the condition the golf ball is hit by the corresponding one of the plurality of golf clubs.

13. The system of claim 7, further comprising:
a plurality of markers, each of the plurality of markers being configured to have an indicator thereon; and
a plurality of golf clubs,
wherein two or more markers are releasably coupled to a corresponding one of the plurality of golf clubs based on the measurement of distance associated with how far the golf ball travels according to a swing type used by the golfer with the corresponding one of the plurality of golf clubs, each of the swing types resulting in a different measure of distance.

14. The system of claim 13, wherein the swing type is one of a straight shot, a draw shot, a fade shot, and less-than-full-powered shot.

15. The system of claim 7, further comprising:
a plurality of markers, each of the plurality of markers being configured to have an indicator thereon; and
a plurality of golf clubs,
wherein two or more markers are releasably coupled to a corresponding one of the plurality of golf clubs based on the measurement of distance associated with how far the golf ball travels according to conditions of a golf course, each of the conditions resulting in a different measure of distance.

16. The system of claim 15, wherein the conditions are one of an uphill lie, a downhill lie, a sidehill lie, weather, and grass type.

17. A method of labeling a golf club set, the method comprising:
providing a set of golf clubs;
providing a set of markers having indicators thereon, the indicators displaying a number;
selecting a golf club of the set of golf clubs;
hitting a golf ball with the golf club;
measuring a distance the golf ball travels;
identifying which marker among the set of markers displays the number that corresponds to the measured distance; and
coupling the identified marker to the golf club.

18. The method of claim 17, the coupling further comprising:
inserting a shaft of the golf club into an opening on the identified marker;
expanding the opening to receive the shaft;
retracting the opening after receiving the shaft; and
securing the identified marker to the shaft by friction fit.

19. The method of claim 17, the method further comprising:
selecting a second golf club of the set of golf clubs;
hitting a golf ball with the second golf club;
measuring a second distance the golf ball travels;
identifying which marker among the set of markers displays the number that corresponds to the second measured distance; and
coupling the identified marker to the second golf club.

20. The method of claim 17, the method further comprising:
utilizing a different swing type to hit the golf ball with the golf club;
measuring a distance the golf ball travels by the different swing type;
identifying which marker among the set of markers displays the number that corresponds to the measured distance by the different swing type;
coupling the identified marker for the different swing type to the golf club; and
distinguishing the identified marker for the different swing type from the identified marker.
